(19) United States
(12) Patent Application Publication
(10) Pub. No.: US 2022/0166777 A1
(43) Pub. Date: May 26, 2022

(54) ACCESS CONTROL METHOD, SYSTEM, DEVICE, TERMINAL, AND COMPUTER PROGRAM PRODUCT USING MULTIMODAL AUTHENTICITY DETERMINATION

(71) Applicant: Eugenio S. YNION, JR., San Pedro (PH)

(72) Inventor: Eugenio S. YNION, JR., San Pedro (PH)

(21) Appl. No.: 16/490,763

(22) PCT Filed: Jul. 10, 2017
(86) PCT No.: PCT/PH2017/050001

§ 371 Date: Sep. 3, 2019

(30) Foreign Application Priority Data
Mar. 3, 2017 (PH) 1-2017-000064

(51) Int. Cl. H04L 9/40

(52) U.S. Cl. CPC H04L 63/101; H04L 63/0428; H04L 63/0861; H04L 63/102

(57) ABSTRACT

Aspects of the present invention are directed to access control method, system, device, terminal, and computer program product for controlling access to an identity-based access-controlled resource using multimodal authenticity determination for an object of authentication at an access point located in the access-controlled resource. First and second authenticity scores are determined from information on facial recognition and fingerprint authentication modalities. Based on the acceptability of each of the first and second authenticity scores, a third authenticity score is determined from a digital key authentication data uniquely identifying input data associated with any one of the facial recognition and fingerprint authentication. The digital key is generated based at least in part on a determined distance of at least two unique identifier data in relation to one another. The unique identifier data are included in a subset of unique identifier data overlaid to any of reference input data into which the input data are compared. The subset of unique identifier data is randomly selected from a set of unique identifier data generated from any one or more color identifier data in a standardized color matching system such as the Pantone Matching System which provides unique color values whereby no same digital key can be generated for the object of authentication. The uniqueness of the digital key guarantees high level of authentication.

### TECHNICAL FIELD

The present invention relates generally to the field of controlling access to identity-based access-controlled resources. More particularly, the present invention relates to a method, system, electronic device, terminal, and computer program product for controlling access to an identity-based access-controlled resource using multimodal authenticity determination which is directed to an object of authentication at an access point located in the access-controlled resource.

### BACKGROUND ART

An increasing number of computer-based systems can be observed nowadays in the field of controlling access to access-controlled resources in various industries. The resources may range from electronic storage facilities such as electronic databases or database systems containing proprietary information which must be protected from unauthorized access, electronic platforms such as websites designed for decision support systems, physical facilities such as research laboratories, data centers, warehouses, offices, warehouses, car parks, and the like, which are provided with restricted access points such as electronically controlled door and/or gate locks, and to vehicles which are provided with access-controlled automotive ignition systems.

Access to the above-cited non-limiting examples of access-controlled resources is typically identity-based. It means that only authorized users are permitted to gain access to the access-controlled resources. The identities of the users can be authenticated using any one or more of the several biometric validation techniques which are well-known in the art. Pass codes or personal identification numbers (PINs) can also be used in conjunction with these biometric validation techniques to increase the security level of authentication.

However, the use of pass codes which are based on dynamic datasets generated by computer systems using various random number selection methods, techniques, or algorithms compromises the security level of authentication for use in such access-controlled resources on each possible occurrence of repeating random numbers. In such an unavoidable event, two or more users may be provided by computer systems with identical pass codes which are a security risk in authentication systems. The use of user-supplied pass codes, on the other hand, also presents similar technical problem wherein uniqueness of the user-supplied pass codes is likewise never guaranteed.

### SUMMARY OF THE INVENTION

Aspects of the present invention are directed to access control method, system, device, terminal, and computer program product for controlling access to an identity-based access-controlled resource using multimodal authenticity determination for an object of authentication at an access point located in the access-controlled resource. First and second authenticity scores are determined from information on facial recognition and fingerprint authentication modalities. Based on the acceptability of each of the first and second authenticity scores, a third authenticity score is determined from a digital key authentication data uniquely identifying input data associated with any one of the facial recognition and fingerprint authentication. The digital key is generated based at least in part on a determined distance of at least two unique identifier data in relation to one another. The unique identifier data are included in a subset of unique identifier data overlaid to any of reference input data into which the input data are compared. The subset of unique identifier data is randomly selected from a set of unique identifier data generated from any one or more color identifier data in a standardized color matching system such as the Pantone Matching System which provides unique color values whereby no same digital key can be generated for the object of authentication.

The provision of generating the digital key based on the relative distance of the randomly selected and overlaid unique identifier data originating from color identifier data in the standardized color matching system, such as the well-known Pantone Matching System, guarantees the uniqueness of the digital key for each object of authentication. In other words, this arrangement guarantees that no same digital key can be generated for a single object of authentication. Security risks which are associated with identical pass codes in authentication systems and high level of authentication are thereby substantially reduced, if not totally eliminated. Further, security level of authentication is significantly increased with this provision of digital key generation used in conjunction with other authentication modalities in one or more technical frameworks for multimodal authentication determination.

For a better understanding of the invention and to show how the same may be performed, preferred implementations and/or embodiments thereof will now be described, by way of non-limiting examples only, with reference to the accompanying drawings.

### BRIEF DESCRIPTION OF THE SEVERAL VIEWS OF THE DRAWINGS

FIG. 1 is a flow diagram illustrating a method of controlling access to an identity-based access-controlled resource consistent with one or more embodiments of the invention.

FIG. 2 is simplified block diagram graphically illustrating various aspects and implementations of the invention.

FIG. 3 is a detailed block diagram illustrating a system for controlling access to an identity-based access-controlled resource consistent with one or more embodiments of the invention.

FIG. 4 is a flow diagram illustrating an example authentication operation suitable for use in the invention.

FIG. 5 is a flow diagram illustrating an example operation by which facial recognition data are derived from information on facial recognition modality in accordance with an example embodiment of the invention.

FIG. 6 is a flow diagram illustrating an example operation by which fingerprint authentication data are derived from information on fingerprint authentication modality in accordance with an example embodiment of the invention.

FIG. 7 is a flow diagram illustrating digital key authentication data being derived from information on digital key authentication modality in accordance with an example embodiment of the invention.

FIG. 8 is a pictorial diagram showing an enlarged view of the portion of the flow diagram in FIG. 7.

FIG. 8A is a table illustrating example datasets that may be incorporated within a data structure in accordance with one or more embodiments of the invention.

FIG. 9 is a flow diagram illustrating digital key encoding process in accordance with an example embodiment of the invention.

FIG. 10 is a flow diagram illustrating a digital key decoding in accordance with an example embodiment of the invention.

FIG. 11 is a block diagram illustrating example components of an electronic device in accordance with an aspect of the invention.

### DETAILED DESCRIPTION OF THE PREFERRED EMBODIMENTS

One or more execution methods, execution systems, transaction platforms, programming systems, classes, and class objects according to one or more implementations of the present invention, including various computer-designed aspects, processes, sub-processes and configurations of the same, may be implemented on a variety of electronic computing devices and systems, including electronic data access devices and/or electronic server devices, wherein these computing devices include well-known and appropriate processing mechanisms and computer-readable media for storing, fetching, executing, and interpreting computer-readable instructions, such as programming instructions, codes, signals, and/or the like.

Further, the present invention may include procedures for implementing logic control in programmable controllers in distributed control systems in either wired or wireless data networks or data communication systems. All the ensuing disclosures and illustrations of the preferred implementations of the present invention, along with one or more components, features or elements thereof, are merely representative for the purpose of sufficiently describing the manner by which the present invention may be carried out into practice in various ways other than the ones outlined in the ensuing description.

It is to be understood and appreciated by a person skilled in the art or having ordinary skills in the art, however, that the exemplary implementations used to describe how to make and use the present invention may be embodied in many alternative forms and should not be construed as limiting the scope of the appended claims in any manner, absent express recitation of those features in the appended claims. All the exemplary drawings, diagrams and illustrations accompanying the ensuing description should also not be construed as limiting the scope of the appended claims in any manner.

References to “an embodiment,” “one embodiment,” “exemplary embodiment,” “example embodiment,” “various embodiments,” “one or more embodiments,” and so forth indicate that the embodiment(s) of the present disclosure so described may include a particular feature, characteristic, method, structure, or technique, but not every embodiment necessarily includes the particular feature, characteristic, method, structure, or technique. Further, repeated use of these phrases relating to one or more embodiments of the present invention do not necessarily refer to the same embodiment, although they may.

It is also to be understood and appreciated that the use of ordinal terms like “first” and “second” is used herein to distinguish one element, feature, component, calculation or method-step from one another and should not also be construed as limiting the scope of the appended claims, and that these and such other ordinal terms that may appear in the ensuing description are not indicative of any particular order of elements, features, calculations, components or method-steps to which they are attached or with which they are associated. For example, a first element could be termed a second element. Similarly, a second element could be termed a first element. All these do not depart from the scope of the herein disclosure and its accompanying claims.

Unless the context clearly and explicitly indicates otherwise, it is to be understood that like reference numerals refer to like elements throughout the ensuing description of the figures and/or drawings, that the linking term “and/or” includes any and all combinations of one or more of the associated listed items, that the singular terms “a”, “an” and “the” are intended to also include the plural forms, and that some varying terms of the same meaning and objective may be interchangeably used throughout the ensuing disclosure.

As may be used herein, the term “system” may refer to a collection of one or more hardware, software, combinations of hardware and software, or firmware components, and may be used to refer to an electronic computing device or devices, or one or more subsystems thereof, within which one or more sets of computer-executable instructions, which are tangibly embodied in one or more machine-readable media, may be executed by the hardware components in order to perform arithmetic operations, logical operations, timing operations, and specialized functions applicable to specific task objects and consequently produce control outputs and/or control signals associated with the present invention in accordance with one or more implementations and/or embodiments thereof.

As may be used herein, the term “application” is an application which may refer to an executable computer software program that enables services and content associated with parking management and parking reservation to be provided to electronic devices. The app may be a mobile application or any other application that is executable via any suitable client device. The program which may constitute the app may be a self-contained software or is a component of or contained by another program or programs, any of which may be implemented by one or more hardware, software, firmware and/or cloud resources comprising one or more infrastructure stacks and one or more infrastructure components such as application servers, file servers, DNS (domain name system) servers, directory servers, web servers, network servers, database servers, batch servers, and the like.

As may be used herein, the terms “application server,” or “application server device” may refer to a single server computer or a cluster of server computers connected to any suitable communication network such as the Internet. The server device may provide any one or all of the transactional applications, such as logistics management applications, or any similar or comparable computing services to remote electronic client devices such as mobile devices of the smart-phone type. The server computer or cluster of server computers may include software modules capable of receiving and processing one or more requests from client devices through any suitable communication network to which it is connected. The server computer or cluster of server computers may collect and store app records on a database and may execute any or all of the software programs of the present invention for performing various operations and functions.

As may be used herein, the terms “electronic client device” or “client device” may refer to a wireless mobile or non-mobile data communication device such as a mobile phone, a smart-phone, a PDA (personal digital assistant) device, a tablet device, a phablet device, a desktop computer, a laptop computer, and the like. The client device is capable of rendering the parking management app on its user interface from the server device connected to the network. The client device may be used by a human client to gain access to access-controlled resources such as electronic platforms or websites which are designed for decision support systems and which are transactional in nature.

As may be used herein, the terms “communication network” may refer to any number of communication systems which may include a plurality of the client devices, a plurality of the server devices, and a plurality of the node apparatuses preferably adapted for wireless communication with one another. For example, the first communication network may refer to any number of data communication systems including one or more of the following communication networks and/or frameworks: a public or private data network, a hybrid public and private data network, a wired or wireless data network, an IP (Internet Protocol) framework, a WLAN (wireless local area network), a WWAN (wireless wide area network), a GAN (global area network), a MAN (metropolitan area network), an LTE (Long Term Evolution) network of any generation, a mobile WiMax (worldwide interoperability for microwave access) network, an enterprise intranet, the like, and/or combinations thereof.

As may further be used herein, the terms “connected to,” “connecting,” “communicating,” “in communication with,” “in operative communication with,” “interconnected,” or “interconnecting” may include direct connection/communication, indirect connection/communication and/or inferred connection/communication between devices/apparatuses. The direct connection/communication may be provided through one or more hardware, software, firmware, electronic and/or electrical links between devices/apparatuses. The indirect connection/communication may be provided through an intervening member such as a component, an element, a circuit, a module, a device, a node device, and an apparatus between or among devices/apparatuses. The inferred connection/communication, as may be used herein, may be characterized by one device/apparatus being connected to or in operative communication with another device/apparatus by inference, and may include direct and indirect connections/communications.

As may be used herein, the terms “electronic database system” may refer to an electronic relational database management system consisting of one or more databases which are organized according to relationships among datasets and support object-relational constructs. Tangible or virtual data storage resources, which may or may not be co-located in respect of one another and other well-known computer system components, may represent the herein described electronic data database. These resources may store various data including authentication and/or access authorization data which are structured either as a text file, a table, a hash table, a spreadsheet, and the like. Any Structured Query Language (SQL) based hierarchical data store or otherwise non-SQL data store may constitute the herein described electronic database used in conjunction with the present invention.

As may be used herein, the term “modality” may refer to any form or mode of identity-based recognition, authentication, selection, orientation for persons desiring to access-controlled resources such as electronic storage facilities, electronic platforms such as websites, and physical facilities. The electronic storage facilities may be electronic databases containing proprietary information which must be protected from unauthorized access and/or use. The electronic platforms may be websites which are designed for decision support systems, among others. The physical facilities may be research laboratories, data centers, warehouses, offices, warehouses, car parks, or the like.

As may be used herein, the terms “access-controlled resources” may refer to any intangible electronic platform or otherwise tangible physical area and/or structure designed for various purposes. The access-controlled resources may be electronic platforms such as websites designed for decision support systems, physical facilities such as research laboratories, data centers, warehouses, offices, warehouses, car parks, and the like, which are provided with restricted access points such as electronically controlled door and/or gate locks, and to vehicles which are provided with access-controlled automotive ignition systems. It is to be understood and appreciated that any facility, electronic or physical, that is equipped with electronic access control system may be referred to as the herein described access-controlled resource.

Although the ensuing disclosed embodiments of the present invention provide for the use of facial recognition and fingerprint authentication modalities, it is to be understood and appreciated that other well-known biometric authentication modalities may be adapted suitable for use in the method, system, device, terminal, and computer program product of the present invention. These other modalities may include, by way of examples and not by way of limitations, ear shape identification, iris recognition, retina recognition, finger geometry recognition, hand geometry recognition, palm print geometry recognition, signature recognition, speech recognition, vein recognition, gait determination, and the like, as long as they be captured using any suitable biometric profile capturing and/or biometric information confirmation device and processed by a computer from the capturing device for input data generation.

As may be used herein, the terms “authentication parameter” may refer computational features which are associated with one or more authentication, verification and/or confirmation modalities for identity-based recognition, authentication, selection and/or orientation, and which may include one or more values and/or one or more settings of operational variables of the herein described access control method, system, device, terminal, and computer program product using multimodal determination in accordance with one or more preferred embodiments of the present invention.

For example, an identity-based recognition associated with a first modality which is a facial recognition may include authentication parameters for determining positional and/or orientational characteristics and properties of lips, eye, eye brow, and cheek portions of a facial image. For the lips, lip center position (e.g., x-axis_{center}, y-axis_{center}), lip shape (e.g., height₁, height₂, width), and lip orientation (angle theta in first, second, third and fourth quadrants), among others, may be determined as computational features for parametric authentication. For the eyes, boundaries of the eye, whether it be in closed or open eye position, may be modeled by determining two parabolic arcs with at least six parameters (e.g., x-axis_{center}, y-axis_{center}, height₁, height₂, width, angle theta in first, second, third and fourth quadrants) and a circular profile with at least three parameters (e.g., x-axis, y-axis, radius), among others, as computational features for parametric authentication. For the eye brow and cheek, upward oriented and downward triangular templates with any suitable number of authentication parameters or variables may be determined as computational features for parametric authentication.

In another example, an identity-based recognition associated with a second modality which is a fingerprint authentication may include authentication parameters for determining positional and/or orientational characteristics and properties of global features of a fingerprint image. These features for parametric authentication may include, by way of examples and not by way of limitation, singular points, ridge orientation maps, ridge frequency maps, ridge ending, ridge bifurcation, minutiae location, minutiae orientation, number of sweat pores, position of sweat pores, and shape of sweat pores.

As may be used herein, the terms “authenticity score” may refer to an acceptability value obtainable by quantitatively evaluating the accuracy of any given authentication data (e.g., eye boundary related data in the case of facial recognition and minutiae orientation related data in the case of fingerprint authentication) when the same is compared with reference authentication data (e.g., reference eye boundary related data and reference minutiae orientation related data). In evaluating the accuracy of any given authentication data associated with an object of authentication, percentage of errors may be set in order to determine the acceptable threshold score values.

As may be used herein, the terms “object of authentication” may mainly refer to a person or user who desires to access any given access-controlled resource. It is to be understood and appreciated that the object of authentication may not actually refer to a natural person but, alternatively, to a printed or digital representation of the natural person. As such, in one embodiment, printed identification cards containing a feature of a natural person (e.g., face) can be captured and processed by the access control method, system, device, terminal, and computer program product in accordance with one or more preferred embodiments of the present invention. In another embodiment, a graphically rendered facial image of a natural person subject to authentication at an access point in any given access-controlled resource may alternatively be captured and processed through the implementations of the present invention. The rendered facial image may be resident, for example, on a smart-phone owned by the natural person desiring to access the access-controlled facility. The facial image residing on the smart-phone may be accessed locally or remotely through any suitable communication network.

As may be used herein, the terms “digital key” may refer to a hashed key that is commonly used in encryption and decryption in a common key processing algorithm for at a least portion of unique identifier data which are directly or indirectly associated with and/or directly or indirectly derivable from a standardized color matching system. The digital key may be or may include any one of a sequence of bits, a text string, a sequence of random bits, a sequence of pseudorandom bits, or any other similar sequence of data which is a result of and/or specifies a transformation of unencrypted unique identifier data into encrypted unique identifier data in encryption operations, and which is a result of and/or specifies transformation of encrypted unique identifier data into decrypted unique identifier data in decryption operations.

As may be used herein, the terms “standardized color matching system” may refer to an accurate color matching system which provides a color code used together with the equivalent Hexa-decimal value to create a non-repeating numerical equivalent of the color used. The numerical equivalent of one particular color may serve as the unique identifier data of various implementations of the present invention. This accurate color matching system may be based on color libraries, color guides, or color palettes provided by various companies such as PANTONE® <https://www.pantone.com/>, TOYO® <http://www.toyo-color.com/en/>, DIC Corporation <http://www.dic-global.com/en/index.html>, and TRUMATCH® 4-color matching system <https://www.trumatch.com/>, among others.

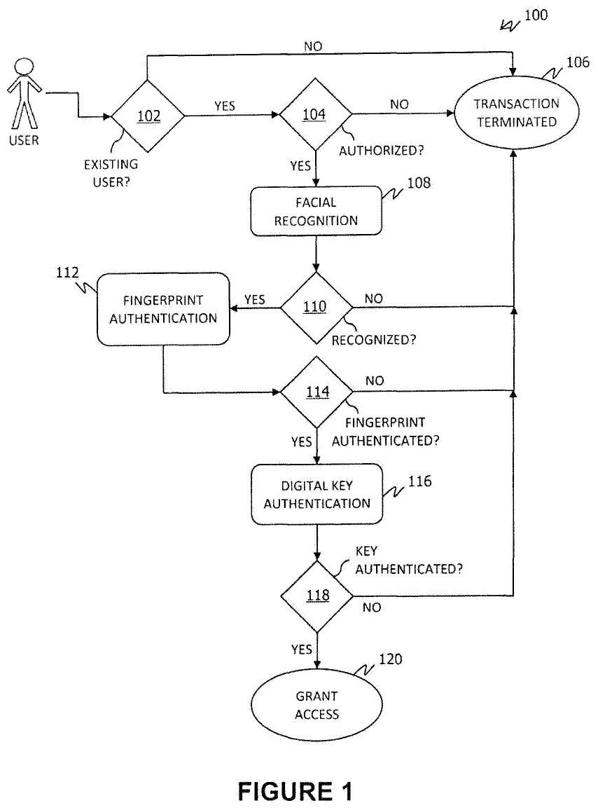

Referring now to FIG. 1, there is shown a flow diagram which illustrates a method of controlling access to an identity-based access-controlled resource consistent with one or more embodiments of the present invention. The method is generally and consistently designated by reference numeral 100 throughout the ensuing description of the preferred embodiments of the present invention. The method 100 is preferably computer-implemented or implemented using hardware and software resources of a computer, a computer system or a network of computers. The method 100 generally utilizes multimodal authenticity determination which may be directed to an object of authentication at an access point located in the access-controlled resource.

The object of authentication may be a person desiring to access the access-controlled resource. The access-controlled resource may be a website designed for decision support system. For example, the website may be operated for supporting logistics operation through which transactions can be performed from receipt of goods to dispatching of the same goods and in which various entities (e.g., shipping company, shipper, customers, broker, trucker, and warehouse operator, and the like) gaining access to the website may be the subject and/or object of authentication/verification.

The accessing person is generally checked whether she or he is an existing user of one or more portions of the logistics operations running through the website (decision step 102) and whether the user is authorized to perform a transaction related to the logistic operations (decision step 104) if the user is an existing user of the logistics operation. If the user is neither an existing user of the logistics operation nor an authorized user to perform the transaction related to the logistics operation, the transaction running through the website may be terminated (terminal step 106).

If the existing user is authorized to perform the transaction, authentication based on a first modality, which may be a facial recognition, may be performed (step 108). This first biometric authentication operation may include the step characterized by receiving a first input data including information on the first modality associated with the object of authentication which is the user. The first input data is preferably a first input image which may be of any suitable image file data commonly used in graphical computing environments such as JPEG data or TIFF data.

Still in the facial recognition operation, the method 100 may continue with the step of deriving a first authentication data from the information on the first modality, i.e., the facial recognition modality, based on at least one first authentication parameter. The first authentication parameter may be based on the first modality, i.e., the facial recognition modality. Effectively, the first authentication parameter is based on the facial recognition. Any one or more suitable authentication parameters can be used in order to complete the facial recognition operation. The method 100 may then proceed to the step of determining at least one first authenticity score for the object of authentication which is the user by comparing the first authentication data with a first reference authentication data associated with the object of authentication and stored in an electronic database. The first reference authentication data may be pre-stored in the electronic database by way of, for example, pre-registration by the user.

If the user is not recognized after the performance of the facial recognition operation (decision step 110), the transaction accompanied by the method 100 may be terminated (terminal step 106). This unsuccessful facial recognition may mean that the first authentication data does not match the first reference authentication data or, alternatively, does not fall within the acceptable threshold associated with first reference authentication data. Otherwise, a successful facial recognition may cause the method 100 to advance to the step of performing a further authentication which may now be based on a second modality. The second modality may be fingerprint authentication which is distinct from the facial recognition (step 112).

In the fingerprint authentication, the method 100 may continue by receiving a second input data including information on the second modality associated with the object of authentication which is the user based on acceptability of the determined at least one first authenticity score, and then by deriving a second authentication data from the information on the second modality which is fingerprint authentication based on at least one second authentication parameter. The second authentication parameter may be based on the second modality, i.e., fingerprint authentication. Effectively, the second authentication parameter is based on the fingerprint authentication. The method 100 may progress by determining at least one second authenticity score for the object of authentication which is the user by comparing the second authentication data with a second reference authentication data associated with the object of authentication which is the user and stored in the electronic database. The second reference authentication data may be pre-stored in the electronic database by way of, for example, pre-registration by the user.

If the user is not authenticated based on her or his fingerprint profile after the performance of the fingerprint authentication operation (decision step 114), the transaction accompanying the method 100 may be terminated (terminal step 106). This unsuccessful fingerprint authentication may mean that the second authentication data does not match the second reference authentication data or, alternatively, does not fall within the acceptable threshold associated with second reference authentication data. Otherwise, a successful fingerprint authentication may cause the method 100 to advance to the step of performing a further authentication which may now be based on a third modality. The third modality may be digital key authentication which is distinct from any one of the previously performed facial recognition and the fingerprint authentication (step 116).

In the digital key authentication, the method 100 may include the step of receiving the third authentication data, i.e., the digital key, uniquely identifying the any of the first and second input data, which are illustrated herein as input image data, based on acceptability of the determined at least one second authenticity score, the step of determining at least one third authenticity score for the object of authentication which is the user by comparing the third authentication data with a third reference authentication data associated with the object of authentication and stored in the electronic database. The third reference authentication data may be pre-stored in the electronic database by way of, for example, pre-registration by the user.

If the user is not authenticated based on the third authentication data, i.e., the digital key associated with him or her, after the performance of the digital key authentication operation (decision step 118), the transaction accompanied by the method 100 may be terminated (terminal step 106). This unsuccessful digital key authentication may mean that the third authentication data, i.e., the digital key, does not match the third reference authentication data or, alternatively, does not fall within the acceptable threshold associated with third reference authentication data. Otherwise, a successful digital key authentication may cause the method 100 to advance to the step of causing an access control unit at the access point to grant access to the access-controlled resource based on acceptability of the determined at least one third authenticity score (step 120).

Accordingly, the third reference authentication data includes the digital key, which may be at least one digital key, generated based at least in part on a determined distance of at least two unique identifier data in relation to one another. The at least two unique identifier data are included in a subset of unique identifier data overlaid to any of a reference first input data into which the first input data is compared and a reference second input data into which the second input data is compared. The subset of unique identifier data is randomly selected from a set of unique identifier data. The set of unique identifier data is generated from any one or more color identifier data in any pre-configured standardized color matching system.

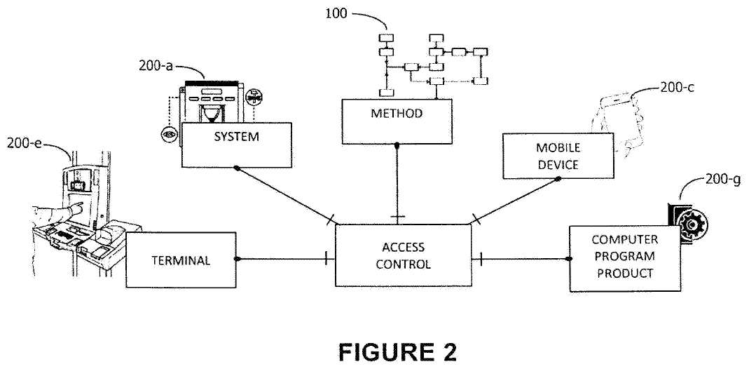

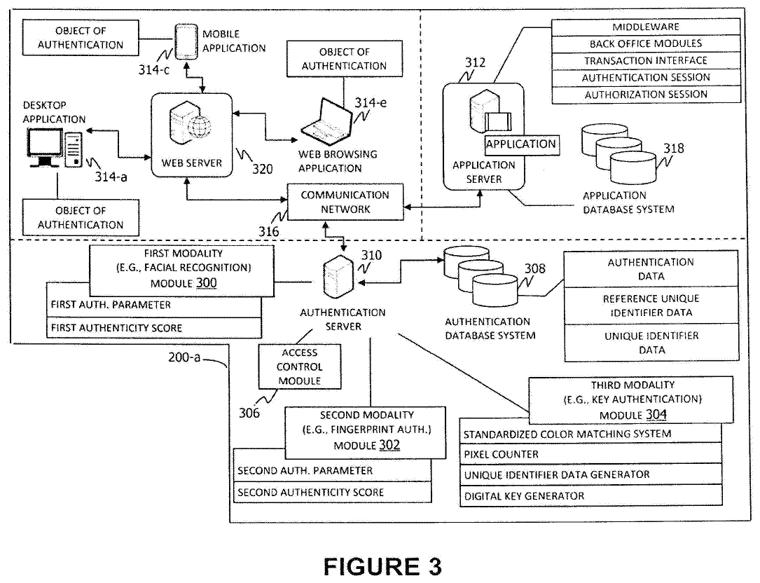

Referring now to FIG. 2, there is shown a simplified block diagram which graphically illustrates various aspects and implementations of the present invention. These access control aspects of the present invention are directed to the above-described computer-implemented method 100, a computer-based system 200-a, an electronic device which may be a mobile device 200-c, a machine or terminal 200-e, and a computer program product 200-g. In FIG. 3, there is shown a detailed block diagram which illustrates the system 200-a for controlling access to the identity-based access-controlled resource consistent with one or more embodiments of the present invention.

The computer-based system 200-a is arranged for controlling access to an identity-based access-controlled resource using multimodal authenticity determination, wherein the multimodal authenticity determination is directed to the object of authentication at the access point located in the access-controlled resource. The system 200-a comprises a first authentication module which may be a facial recognition module 300, a second authentication module which may be a fingerprint authentication module 302, a third authentication module which may be a digital key authentication module 304, and an access control module 306 which may be in operative communication with one another, and which may be residing on an electronic authentication database system 308 associated with an authentication server 310.

The herein described authentication data, unique identifier data, and reference unique identifier data, among other data, may be stored in the authentication database system 308 and may be used by any one of the facial recognition module 300, fingerprint authentication module 302, digital key authentication module 304, and access control module 306. The herein described authentication data, unique identifier data, and reference unique identifier data, among other data, may also be accessible from the authentication database system 308 based on user access request from any of the electronic client devices 314-a, 314-c, 314-e over the communication network 316. The herein described authentication data, unique identifier data, and reference unique identifier data, among other data, may also be accessible from the authentication database system 308 based on an access request from the application server 312 over the communication network 316.

The authentication server 310 may be in operative communication with the application server 312 over the communication network 316. The application server 312 may include an application database system 318 from which a transaction application may be accessed by any of the electronic client devices 314-a, 314-c, 314-e and the authentication server 310. The transaction application may be any application which requires the herein disclosed multimodal authentication determination in order for it be accessed and used for performing various types of electronic transactions.

In some embodiments, the transaction application residing on the application server 312 may include, or may be characterized by having and/or providing, middleware, back-office modules, transaction interface, authentication session, and authorization session. The transaction application may be accessed from any of the client devices 314-a, 314-c, 314-e using a web browsing application (e.g., Google Chrome, Mozilla Firefox, Safari, and the like) executing thereon through the web server 320 which is in communication with the application server 312 over the communication network 316.

The first authentication module or the facial recognition module 300 may be configured to receive the first input data including information on the first modality (i.e., facial recognition) associated with the object of authentication, derive the first authentication data from the information on the first modality based on at least one first authentication parameter, wherein the at least one first authentication parameter is based on the first modality, and determine at least one first authenticity score for the object of authentication by comparing the first authentication data with the first reference authentication data associated with the object of authentication and stored in an electronic database which may be part of the authentication database system 308 in communication with the authentication server 310.

The second authentication module or the fingerprint authentication module 302 may be configured to receive the second input data including information on the second modality (i.e., fingerprint authentication) associated with the object of authentication based on acceptability of the determined at least one first authenticity score, derive a second authentication data from the information on the second modality based on at least one second authentication parameter, wherein the at least one second authentication parameter is based on the second modality, and determine at least one second authenticity score for the object of authentication by comparing the second authentication data with the second reference authentication data associated with the object of authentication and stored in the electronic database of the authentication database system 308.

The third authentication module or the digital key authentication module 304 may be configured to receive the third authentication data uniquely identifying the any of the first and second input data based on acceptability of the determined at least one second authenticity score, and determine at least one third authenticity score for the object of authentication by comparing the third authentication data with the third reference authentication data associated with the object of authentication and stored in the electronic database of the authentication database system 308.

Still in the system 200-a, the third reference authentication data includes at least one digital key generated based at least in part on a determined distance of at least two unique identifier data in relation to one another. The digital key may be generated by the digital key generator associated with the digital key authentication module 304. The distance of the at least two unique identifier data in relation to one another may be determined by a pixel counter associated with the digital key authentication module 304. The at least two unique identifier data are included in the subset of unique identifier data overlaid to any of the reference first input data into which the first input data is compared and the reference second input data into which the second input data is compared. The subset of unique identifier data is randomly selected from the set of unique identifier data. The set of unique identifier data is generated from any one or more color identifier data in the standardized color matching system associated with the digital key authentication module 304. Applications and/or contents associated with the standardized color matching system may be locally stored on the authentication server 310 or, otherwise, remotely accessible from any third-party resources through the communication network 316.

The access control module 306 may be configured to cause any access control unit at the access point to grant access to the access-controlled resource based on acceptability of the determined at least one third authenticity score. The access control unit may be triggered, electronically or physically, directly or indirectly, by the access control module 306 to permit or deny access to the access-controlled resource depending on the acceptability of the third authenticity score. For example, permission to access a permission-based website may be granted electronically by way of enabling algorithms; whereas, permission to access a permission-based research facility may be granted physically by way of actuating mechanical barriers.

In others aspects of the present invention, provided are the mobile device 200-c and the machine or terminal 200-e, each of which is arranged for controlling access to the identity-based access-controlled resource using multimodal authenticity determination directed to the object of authentication at the access point located in the access-controlled resource. In alternative embodiments, each of the electronic device 200-c and terminal 200-e may include the facial recognition module 300 associated with configured to receive the first input data including information on the first modality associated with the object of authentication, derive the first authentication data from the information on the first modality based on at least one first authentication parameter, wherein the at least one first authentication parameter is based on the first modality, and determine at least one first authenticity score for the object of authentication by comparing the first authentication data with the first reference authentication data associated with the object of authentication and stored in an electronic database.

In alternative embodiments, each of the electronic device 200-c and terminal 200-e may include the fingerprint authentication module 302 configured to receive a second input data including information on a second modality associated with the object of authentication based on the acceptability of the determined at least one first authenticity score, derive a second authentication data from the information on the second modality based on at least one second authentication parameter, the at least one second authentication parameter being based on the second modality, and determine at least one second authenticity score for the object of authentication by comparing the second authentication data with a second reference authentication data associated with the object of authentication and stored in the electronic database.

In alternative embodiments, each of the electronic device 200-c and terminal 200-e may include the third authentication module 304 configured to receive a third authentication data uniquely identifying the any of the first and second input data based on acceptability of the determined at least one second authenticity score, and determine at least one third authenticity score for the object of authentication by comparing the third authentication data with a third reference authentication data associated with the object of authentication and stored in the electronic database.

In each of the electronic device 200-c and terminal 200-e, the third reference authentication data includes at least one digital key generated based at least in part on the determined distance of at least two unique identifier data in relation to one another. The at least two unique identifier data are included in the subset of unique identifier data overlaid to any of the reference first input data into which the first input data is compared and the reference second input data into which the second input data is compared. The subset of unique identifier data is randomly selected from the set of unique identifier data. The set of unique identifier data is generated from any one or more color identifier data in the standardized color matching system.

In alternative embodiments, each of the electronic device 200-c and terminal 200-e may include the access control module 306 configured to cause any access control unit at the access point to grant access to the access-controlled resource based on acceptability of the determined at least one third authenticity score. The access control unit may be triggered, electronically or physically, by the access control module 306 to permit or deny access to the access-controlled resource depending on the acceptability of the third authenticity score.

In one aspect of the present invention, the computer program product 200-g is provided. The computer program product 200-g comprises a non-transitory computer-usable medium having a computer-readable program code embodied therein. The computer-readable program code causes a computer to implement a method of controlling access to an identity-based access-controlled resource using multimodal authenticity determination. The multimodal authenticity determination is directed to an object of authentication at the access point located in the access-controlled resource.

In the computer program product 200-g, the method comprises: (i) receiving the first input data including information on the first modality associated with the object of authentication; (ii) deriving the first authentication data from the information on the first modality based on at least one first authentication parameter, wherein the at least one first authentication parameter is based on the first modality; (iii) determining at least one first authenticity score for the object of authentication by comparing the first authentication data with the first reference authentication data associated with the object of authentication and stored in the electronic database; (iv) receiving the second input data including information on a second modality associated with the object of authentication based on the acceptability of the determined at least one first authenticity score; (v) deriving the second authentication data from the information on the second modality based on at least one second authentication parameter, wherein the at least one second authentication parameter is based on the second modality; (vi) determining at least one second authenticity score for the object of authentication by comparing the second authentication data with the second reference authentication data associated with the object of authentication and stored in the electronic database; (vii) receiving the third authentication data uniquely identifying the any of the first and second input data based on the acceptability of the determined at least one second authenticity score; (viii) determining at least one third authenticity score for the object of authentication by comparing the third authentication data with the third reference authentication data associated with the object of authentication and stored in the electronic database; and (ix) causing an access control unit at the access point to grant access to the access-controlled resource based on acceptability of the determined at least one third authenticity score, wherein the third reference authentication data includes at least one digital key generated based at least in part on a determined distance of at least two unique identifier data in relation to one another, wherein the at least two unique identifier data are included in the subset of unique identifier data overlaid to any of the reference first input data into which the first input data is compared and the reference second input data into which the second input data is compared, wherein the subset of unique identifier data is randomly selected from the set of unique identifier data, and wherein the set of unique identifier data is generated from any one or more color identifier data in the standardized color matching system.

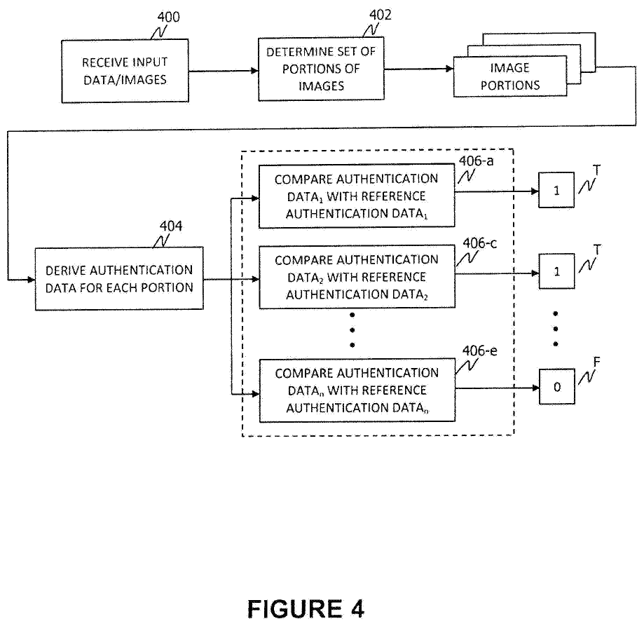

Referring to FIG. 4, there is shown a flow diagram which illustrates an example authentication operation suitable for use in the invention. In one or more aspects of the present invention, the determination of each of the first, second, third authenticity scores includes extracting at least one portion of each of the first input data, respectively. At step 400, input data which are preferably input images are received. These input images may be captured by image-capturing units (such as camera components) of the electronic client devices 314-a, 314-c, 314-e, or of the terminal 200-e and mobile device 200-c. At step 402, a set of portions of the images is determined and extracted from the received input images. At step 404, authentication data for each portion of the plurality of the image portions are derived. At steps 406-a, 406-c, 406-e, depending on the available number of authentication data derived from the image portions and on the number of authentication parameters to be applied against the derived authentication data, each of the derived authentication data is compared with reference authentication data. This authentication operation may be suitable for use in the facial recognition, fingerprint authentication, and digital key authentication operations in accordance with one or more embodiments and/or computer-based aspects of the present invention.

The comparison may result in a true or false value. The true value may be indicative of a matching derived authentication data and reference authentication data. The true value may also indicate that the derived authentication data falls within a predetermined threshold value for the reference authentication data. The false value may be indicative of a mismatching derived authentication data and reference authentication data. The false value may also indicate that the derived authentication data falls outside the predetermined threshold value for the reference authentication data. The threshold values may be customizable depending on acceptable values of the derived authentication data based on the reference authentication data.

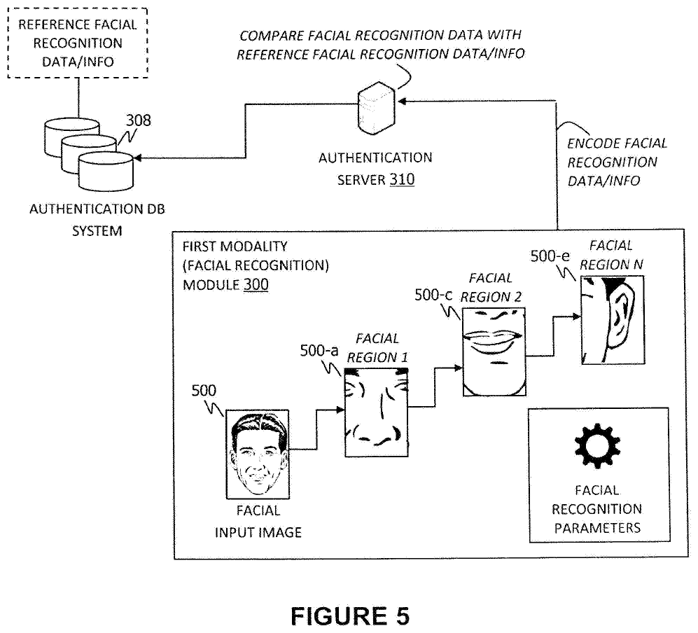

Referring to FIG. 5, there is shown a flow diagram which illustrates an example operation by which facial recognition data are derived from information on facial recognition modality in accordance with an example embodiment of the present invention. The illustrated non-limiting example of facial recognition operation, as illustrated in any portion of the accompanying drawings, may include receiving a facial image 500 and consequently extracting or obtaining multiple portions or regions 500-a, 500-c, 500-e of the facial image 500 by the first modality module or facial recognition module 300. The positional and/or orientational characteristics and properties of the nose portion/region 500-a, lips portion/region 500-c, and ear portion/region 500-e of the facial image 500 may be determined using facial recognition parameters. The facial recognition module 300 encodes the facial recognition data or information based on the determined positional and/or orientational characteristics and properties of the facial portions/regions 500-a, 500-c, 500-e of the facial image 500.

The facial recognition module 300 may then cause the transmission of the encoded facial recognition data or information to the authentication server 310 which, in turn, is triggered to perform comparison of the received encoded facial recognition data with reference facial recognition data or information pre-stored in the authentication database system 308. The received encoded facial recognition data along with the result of the comparison between the received encoded facial recognition data and the reference facial recognition data or information may be caused by the authentication server 310 to be stored in the authentication database system 308.

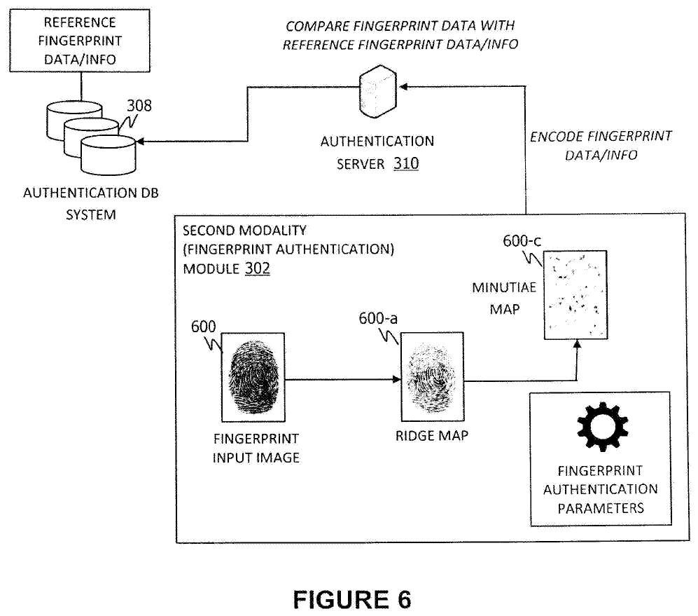

Referring to FIG. 6, there is shown a flow diagram which illustrates an example operation by which fingerprint authentication data are derived from information on fingerprint authentication modality in accordance with an example embodiment of the present invention. The illustrated non-limiting example of fingerprint authentication operation may include receiving a fingerprint image 600 and consequently extracting or obtaining a ridge map 600-a and then a minutiae map 600-c of the fingerprint image 600 by the second modality module or fingerprint authentication module 302. The positional and/or orientational characteristics and properties various points in the minutiae map 600-c may be determined using fingerprint authentication parameters. The fingerprint authentication module 302 encodes the fingerprint authentication data or information based on the determined positional and/or orientational characteristics and properties of the plurality of points in the minutiae map 600-c of the fingerprint image 600.

The fingerprint authentication module 302 may then cause the transmission of the encoded fingerprint authentication data or information to the authentication server 310 which, in turn, is triggered to perform comparison of the received encoded fingerprint authentication data with reference fingerprint authentication data or information pre-stored in the authentication database system 308. The received encoded fingerprint authentication data along with the result of the comparison between the received encoded fingerprint authentication data and the reference fingerprint authentication data or information may be caused by the authentication server 310 to be stored in the authentication database system 308.

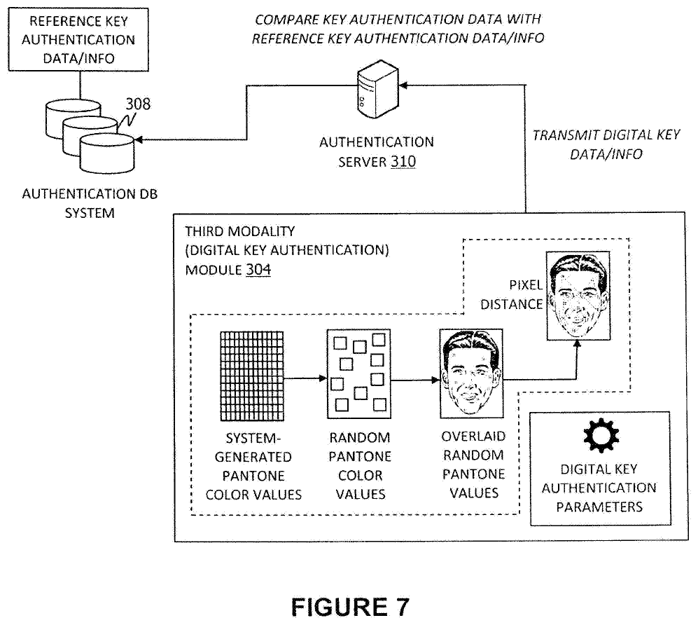

Referring to FIG. 7, there is shown a flow diagram which illustrates an example operation by which digital key authentication data being derived from information on digital key authentication modality in accordance with an example embodiment of the present invention. The illustrated non-limiting example of digital key authentication operation may include receiving an authentication data or the digital key and consequently decoding the digital key. The digital key authentication module 304 may then cause the transmission of the decoded key authentication data or information to the authentication server 310 which, in turn, is triggered to perform comparison of the received encoded key authentication data with reference key authentication data or information pre-stored in the authentication database system 308. The received key authentication data along with the result of the comparison between the received key authentication data and the reference key authentication data or information may be caused by the authentication server 310 to be stored in the authentication database system 308.

In some embodiments, the digital key authentication module 304 may be arranged to: (i) generate the set of unique identifiers from the standardized color matching system; (ii) randomly select the subset of unique identifiers from the set of unique identifiers; (iii) overlay the subset of unique identifiers to any one of first and second input data; (iii) determine the distance of at least two unique identifiers included in the overlaid subset of unique identifiers in relation to one another; and (iii) generating at least one digital key based at least in part on the determined distance of the at least two unique identifiers, wherein the at least one digital key uniquely identifies the any of the first and second input data to which the unique identifiers included in the subset of unique identifiers are overlaid.

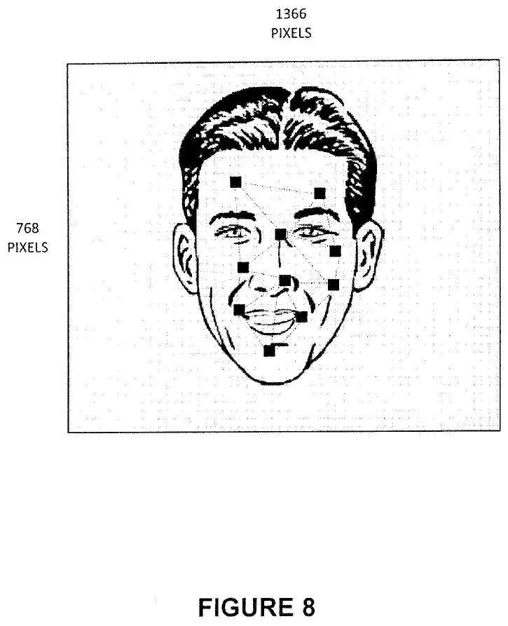

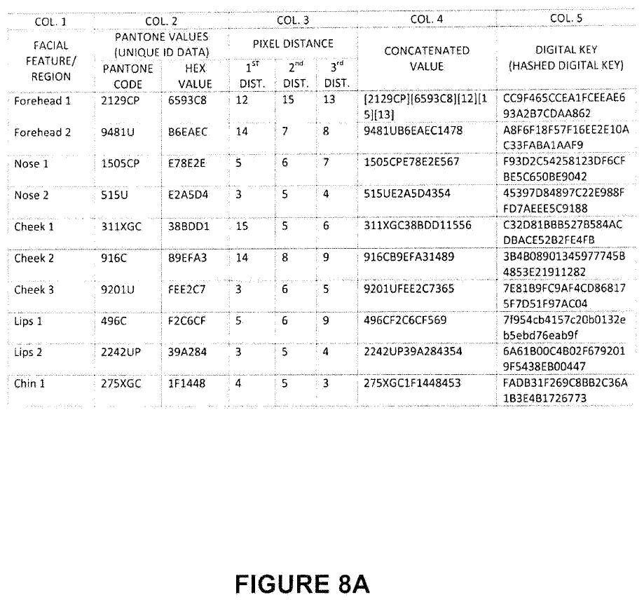

FIG. 8 is a pictorial diagram showing an enlarged view of the portion of the flow diagram in FIG. 7. This enlarged view specifically shows a facial image on which a subset of ten (10) unique identifier data is overlaid. The facial image may be rendered on 1366×768 pixels of a display screen. This pixel size is the standard resolution of a typical computer monitor screen. As in the given example illustration of the facial image rendered on the a 1366×768 pixel sized display screen, the 10 unique identifier data serve as 10 distinct points plotted all throughout the facial image in a random manner. Specifically illustrated are two unique identifier data or points plotted on the forehead portion/region of the facial image, another two unique identifier data or points on the nose portion/region of the facial image, three identifier data or points on the cheek portion/region of the facial image, two unique identifier data or points on the lips portion/region of the facial image, and one unique identifier data or point on the chin portion/region of the facial image.

Referring to FIG. 8A is a table illustrating example datasets that may be incorporated within a data structure in accordance with one or more embodiments of the present invention. This data structure may include various datasets derived from the facial feature/portion/region as exemplary illustrated in FIG. 8A (Column 1), from Pantone Matching System (primary column 2), from the facial image-overlaid unique identifier data (primary column 3), from concatenated values (column 4), and from hashed digital key (column 5). Effectively, the digital key is a hashed digital key. It is to be understood and appreciated that this illustrated table shows mere examples of datasets and is therefore non-limiting in scope.

As illustrated in the primary column 2, the Pantone color values include a pantone color code and its corresponding hexadecimal color value for each facial feature/portion/region. The illustrated 10 Pantone color values constituting as a subset of unique identifier data may be randomly selected by a computer operation using any suitable algorithm from one-hundred (100) Pantone color values or codes constituting as the set of unique identifier data generated by the same computer operation for a specific period of time. Put differently, the one or more color identifier data include one or more unique color codes from the Pantone Matching System, and the one or more color identifier data include one or more hexadecimal values associated with the one or more color codes from the Pantone Matching System.

Uniqueness of the color values is guaranteed since, out of 100 Pantone color values generated for any given time period and 10 Pantone color values randomly selected from that same 100 Pantone color values, there is a total of around 17 trillion or approximately 17.3×10² possible combinations of Pantone color values which are valid over that same time period. This uniqueness of the digital key guarantees high level of authentication.

It is to be understood and appreciated that any number of Pantone color values acting as the subset of unique identifier data may be selected from any number of Pantone color values acting as the set of unique identifier data may be adapted for use in one or more aspects of the present invention in order to increase or otherwise decrease the possible number of combinations of the Pantone color values. This adjustment on the number of combinations of the Pantone color values may depend on any desired security level of authentication. Higher security level of authentication is always desirable from the viewpoint of preventing unauthorized access.

As illustrated in the primary column 3, three (3) distance measurements are obtained from each one (1) of the plotted Pantone color values in relation to at least three (3) other plotted Pantone color values. These other plotted Pantone color values may be neighboring plotted Pantone color values. Each of these distance measurements may be based on the number pixels between two (2) of the plotted Pantone color values. The determination of the number of pixels may be based on any given size of a display screen and may vary from one display screen to another. It is to be understood and appreciated that the present invention may be arranged to employ any number of distance measurements obtained from any one (1) of the plotted Pantone color values in relation to any number of the other plotted Pantone color values or neighboring plotted Pantone color value.

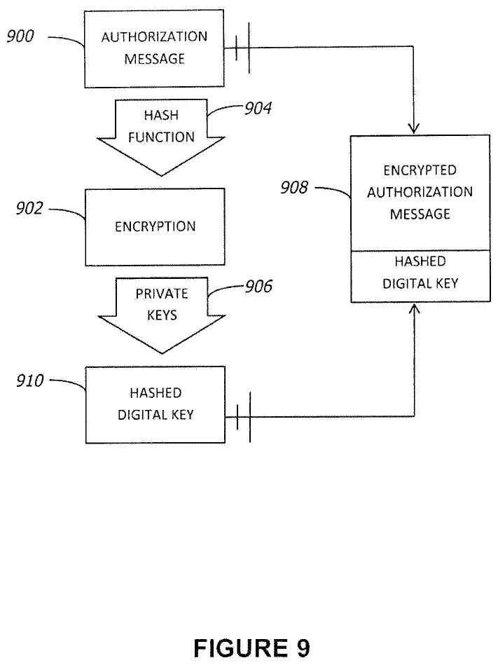

Referring to FIG. 9, there is shown a flow diagram which illustrates digital key encoding process in accordance with an example embodiment of the present invention. A transaction message in general or a transaction authorization message 900 in particular may undergo an encryption process 902 by way of applying any well-known hash function 904. The authorization message 900 may be generated by the herein described transaction application. In one embodiment, the authorization message 900 may be digitally encrypted using private keys 906. Those skilled in the art shall recognize well-known methods and techniques that can be used to encrypt the authorization message 900 while utilizing the hash function 904 and the private keys 906 in order to generate an encrypted authorization message 908 with hashed digital key 910. The encrypted authorization message 908 ensures integrity of the data which are associated with the authorization message 900. The encrypted authorization message 908 may be subjected to validation or authentication using digital key authentication parameters. The encrypted authorization message 908 may be stored and also retrievable on-demand in a persistent memory component of any electronic device executing the transaction application/app through any web browser or web browsing application.

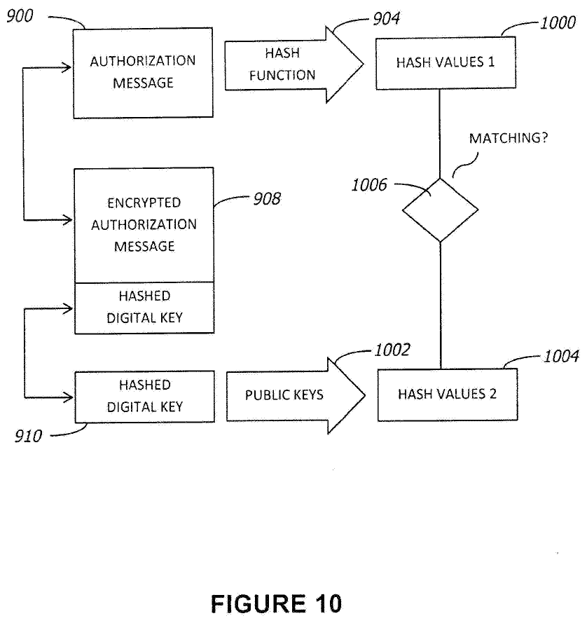

Referring to FIG. 10, there is shown a flow diagram which illustrates a digital key decoding in accordance with an example embodiment of the present invention. The authentication server may be enabled to extract, using the hash function 904, a first set of hash values 1000 from the transaction authorization message 900 which is derived from the encrypted transaction authorization message 908 or the transaction authorization message that is digitally encrypted. Simultaneously, or one after the other, the authenticating server may also be enabled to extract, using public keys 1002, a second set of hash values 1004 from the hashed digital key 910 which is derived from the encrypted transaction authorization message 908 or the transaction authorization message that is digitally encrypted. At decision step 1006, the first set of hash values 1000 and the second set of hash values 1004 may be compared with one another to determine if they are matching with one another. A matching set of the first and second hash values 1000, 1004 may be an indicator that the encrypted transaction authorization message carrying the herein described digital key 908 is authentic in relation to the user who caused the same encrypted transaction authorization message 908 to be generated. Otherwise, a mismatching set of the first and second hash values 1000, 1004 may be an indicator that the encrypted transaction authorization message 908 is not authentic and is potentially generated through fraudulent activities.

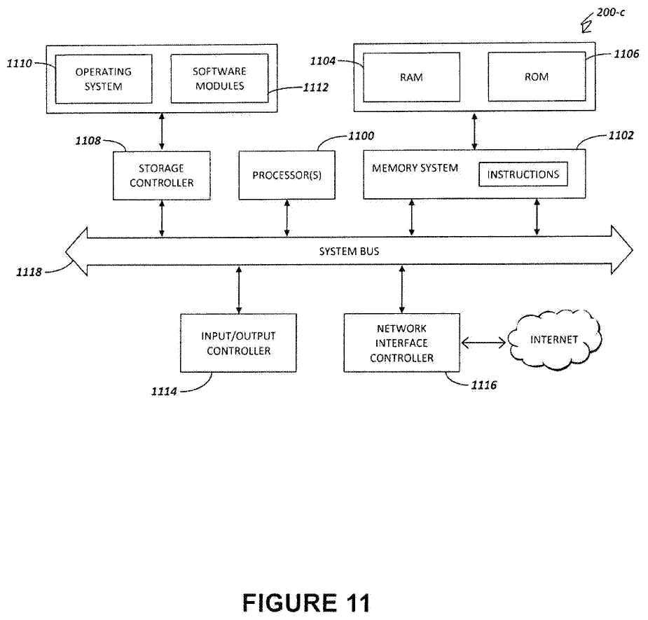

Referring to FIG. 11, there is shown a block diagram which illustrates example components of the electronic device 200-c in accordance with an aspect of the present invention. The electronic device 202-c, which may be a mobile device 200-c, may be implemented as a variety of devices which may include a PDA (personal digital assistant), a media player, a desktop computer, a laptop computer, a tablet computer, a notebook computer, a netbook computer, a notebook computer, a phablet computer, a smart-phone and other electronic devices having physical resources which support short-range, medium-range and/or long-range radio communications, and as well as wired or wireless packet-based data communications. Computing devices such as these are employed with combined hardware and software techniques that can be utilized to provide cooperative multitasking which enables applications or software applications, such as client and web browsing applications alongside with another application, to be executed and run simultaneously.

The mobile device 200-c may include the processor or processors 1100 and the memory system 1102 which may include a RAM (Random Access Memory) 1104 and a ROM (Read-Only Memory) 1106. On the memory system 1102, stored are computer-executable instructions. The mobile device 200-c may also include a storage controller 1108 on which an operating system 1110 and software modules 1112 may be made operable, an input/output controller 1114, and a network interface controller 1116. The network interface controller 1116 enables the mobile device 200-c to communicate with other access devices or computing devices over any suitable communication network (such as the Internet). The illustrated components of the mobile device 200-c may communicate with one another through a well-known system bus 1118 of the mobile device 200-c.

In one aspect of the present invention, when the computer-executable instructions are executed by the processor 1100, the processor 1100 is caused to perform the operations which include: (i) generating a set of unique identifiers from a standardized color matching system; (ii) randomly selecting the subset of unique identifiers from the set of unique identifiers; (iii) overlaying the subset of unique identifiers to any one of first and second input data; (iii) determining the distance of at least two unique identifiers included in the overlaid subset of unique identifiers in relation to one another; and (iii) generating at least one digital key based at least in part on the determined distance of the at least two unique identifiers, wherein the at least one digital key uniquely identifies the any of the first and second input data to which the unique identifiers included in the subset of unique identifiers are overlaid.

While the present invention has been described with respect to a limited number of implementations/embodiments, those skilled in the art, having benefit of this disclosure, will appreciate that other implementations/embodiments can be devised which do not depart from the scope of the present invention as disclosed herein.

1. A computer-implemented method of controlling access to an identity-based access-controlled resource using multimodal authenticity determination, the multimodal authenticity determination being directed to an object of authentication at an access point located in the access-controlled resource, the method comprising:
receiving a first input data including information on a first modality associated with the object of authentication;
deriving a first authentication data from the information on the first modality based on at least one first authentication parameter, the at least one first authentication parameter being based on the first modality;
determining at least one first authenticity score for the object of authentication by comparing the first authentication data with a first reference authentication data associated with the object of authentication and stored in an electronic database;
receiving a second input data including information on a second modality associated with the object of authentication based on acceptability of the determined at least one first authenticity score;
deriving a second authentication data from the information on the second modality based on at least one second authentication parameter, the at least one second authentication parameter being based on the second modality;
determining at least one second authenticity score for the object of authentication by comparing the second authentication data with a second reference authentication data associated with the object of authentication and stored in the electronic database;
receiving a third authentication data uniquely identifying the any of the first and second input data based on acceptability of the determined at least one second authenticity score;
determining at least one third authenticity score for the object of authentication by comparing the third authentication data with a third reference authentication data associated with the object of authentication and stored in the electronic database; and
causing an access control unit at the access point to grant access to the access-controlled resource based on acceptability of the determined at least one third authenticity score,
wherein the third reference authentication data includes at least one digital key generated based at least in part on a determined distance of at least two unique identifier data in relation to one another, the at least two unique identifier data being included in a subset of unique identifier data overlaid to any of a reference first input data into which the first input data is compared and a reference second input data into which the second input data is compared, the subset of unique identifier data being randomly selected from a set of unique identifier data, the set of unique identifier data being generated from any one or more color identifier data in a standardized color matching system.

2. The method according to claim 1, wherein the determining of the at least one first authenticity score includes extracting at least one portion of the first input data.

3. The method according to claim 1, wherein the determining of the at least one second authenticity score includes extracting at least one portion of the second input data.

4. The method according to claim 1, wherein the determining of the at least one third authenticity score includes extracting at least one portion of the third authentication data.

5. The method according to claim 1, wherein the first modality is a facial recognition.

6. The method according to claim 5, wherein the first authentication parameter is based on the facial recognition.

7. The method according to claim 1, wherein the second modality is a fingerprint authentication.

8. The method according to claim 7, wherein the second authentication parameter is based on the fingerprint authentication.

9. The method according to claim 1, wherein the standardized color matching system is Pantone Matching System.

10. The method according to claim 9, wherein the one or more color identifier data include one or more unique color codes from the Pantone Matching System.

11. The method according to claim 10, wherein the one or more color identifier data include one or more hexadecimal values associated with the one or more color codes from the Pantone Matching System.

12. The method according to claim 1, wherein the digital key is a hashed digital key.

13. A computer-based system for controlling access to an identity-based access-controlled resource using multimodal authenticity determination, the multimodal authenticity determination being directed to an object of authentication at an access point located in the access-controlled resource, the system comprising:
a first authentication module configured to receive a first input data including information on a first modality associated with the object of authentication, derive a first authentication data from the information on the first modality based on at least one first authentication parameter, the at least one first authentication parameter being based on the first modality, and determine at least one first authenticity score for the object of authentication by comparing the first authentication data with a first reference authentication data associated with the object of authentication and stored in an electronic database;
a second authentication module configured to receive a second input data including information on a second modality associated with the object of authentication based on acceptability of the determined at least one first authenticity score, derive a second authentication data from the information on the second modality based on at least one second authentication parameter, the at least one second authentication parameter being based on the second modality, and determine at least one second authenticity score for the object of authentication by comparing the second authentication data with a second reference authentication data associated with the object of authentication and stored in the electronic database;
a third authentication module configured to receive a third authentication data uniquely identifying the any of the first and second input data based on acceptability of the determined at least one second authenticity score, and determine at least one third authenticity score for the object of authentication by comparing the third authentication data with a third reference authentication data associated with the object of authentication and stored in the electronic database; and
an access control module configured to cause an access control unit at the access point to grant access to the access-controlled resource based on acceptability of the determined at least one third authenticity score,
wherein the third reference authentication data includes at least one digital key generated based at least in part on a determined distance of at least two unique identifier data in relation to one another, the at least two unique identifier data being included in a subset of unique identifier data overlaid to any of a reference first input data into which the first input data is compared and a reference second input data into which the second input data is compared, the subset of unique identifier data being randomly selected from a set of unique identifier data, the set of unique identifier data being generated from any one or more color identifier data in a standardized color matching system.

14. A terminal for controlling access to an identity-based access-controlled resource using multimodal authenticity determination, the multimodal authenticity determination being directed to an object of authentication at an access point located in the access-controlled resource, the terminal comprising:
a first authentication module configured to receive a first input data including information on a first modality associated with the object of authentication, derive a first authentication data from the information on the first modality based on at least one first authentication parameter, the at least one first authentication parameter being based on the first modality, and determine at least one first authenticity score for the object of authentication by comparing the first authentication data with a first reference authentication data associated with the object of authentication and stored in an electronic database;
a second authentication module configured to receive a second input data including information on a second modality associated with the object of authentication based on acceptability of the determined at least one first authenticity score, derive a second authentication data from the information on the second modality based on at least one second authentication parameter, the at least one second authentication parameter being based on the second modality, and determine at least one second authenticity score for the object of authentication by comparing the second authentication data with a second reference authentication data associated with the object of authentication and stored in the electronic database;
a third authentication module configured to receive a third authentication data uniquely identifying the any of the first and second input data based on acceptability of the determined at least one second authenticity score, and determine at least one third authenticity score for the object of authentication by comparing the third authentication data with a third reference authentication data associated with the object of authentication and stored in the electronic database; and
an access control module configured to cause an access control unit at the access point to grant access to the access-controlled resource based on acceptability of the determined at least one third authenticity score,
wherein the third reference authentication data includes at least one digital key generated based at least in part on a determined distance of at least two unique identifier data in relation to one another, the at least two unique identifier data being included in a subset of unique identifier data overlaid to any of a reference first input data into which the first input data is compared and a reference second input data into which the second input data is compared, the subset of unique identifier data being randomly selected from a set of unique identifier data, the set of unique identifier data being generated from any one or more color identifier data in a standardized color matching system.

15. An electronic device for controlling access to an identity-based access-controlled resource using multimodal authenticity determination, the multimodal authenticity determination being directed to an object of authentication at an access point located in the access-controlled resource, the electronic device comprising:
a first authentication module configured to receive a first input data including information on a first modality associated with the object of authentication, derive a first authentication data from the information on the first modality based on at least one first authentication parameter, the at least one first authentication parameter being based on the first modality, and determine at least one first authenticity score for the object of authentication by comparing the first authentication data with a first reference authentication data associated with the object of authentication and stored in an electronic database;
a second authentication module configured to receive a second input data including information on a second modality associated with the object of authentication based on acceptability of the determined at least one first authenticity score, derive a second authentication data from the information on the second modality based on at least one second authentication parameter, the at least one second authentication parameter being based on the second modality, and determine at least one second authenticity score for the object of authentication by comparing the second authentication data with a second reference authentication data associated with the object of authentication and stored in the electronic database;
a third authentication module configured to receive a third authentication data uniquely identifying the any of the first and second input data based on acceptability of the determined at least one second authenticity score, and determine at least one third authenticity score for the object of authentication by comparing the third authentication data with a third reference authentication data associated with the object of authentication and stored in the electronic database; and
an access control module configured to cause an access control unit at the access point to grant access to the access-controlled resource based on acceptability of the determined at least one third authenticity score,
wherein the third reference authentication data includes at least one digital key generated based at least in part on a determined distance of at least two unique identifier data in relation to one another, the at least two unique identifier data being included in a subset of unique identifier data overlaid to any of a reference first input data into which the first input data is compared and a reference second input data into which the second input data is compared, the subset of unique identifier data being randomly selected from a set of unique identifier data, the set of unique identifier data being generated from any one or more color identifier data in a standardized color matching system.

16. A terminal for controlling access to an identity-based access-controlled resource using multimodal authenticity determination, the multimodal authenticity determination being directed to an object of authentication at an access point located in the access-controlled resource, the terminal comprising:
a first authentication module configured to receive a first input data including information on a first modality associated with the object of authentication, derive a first authentication data from the information on the first modality based on at least one first authentication parameter, the at least one first authentication parameter being based on the first modality, and determine at least one first authenticity score for the object of authentication by comparing the first authentication data with a first reference authentication data associated with the object of authentication and stored in an electronic database;
a second authentication module configured to receive a second input data including information on a second modality associated with the object of authentication based on acceptability of the determined at least one first authenticity score, derive a second authentication data from the information on the second modality based on at least one second authentication parameter, the at least one second authentication parameter being based on the second modality, and determine at least one second authenticity score for the object of authentication by comparing the second authentication data with a second reference authentication data associated with the object of authentication and stored in the electronic database;
a third authentication module configured to receive a third authentication data uniquely identifying the any of the first and second input data based on acceptability of the determined at least one second authenticity score, and determine at least one third authenticity score for the object of authentication by comparing the third authentication data with a third reference authentication data associated with the object of authentication and stored in the electronic database; and
an access control module configured to cause an access control unit at the access point to grant access to the access-controlled resource based on acceptability of the determined at least one third authenticity score,
wherein the third reference authentication data includes at least one digital key generated based at least in part on a determined distance of at least two unique identifier data in relation to one another, the at least two unique identifier data being included in a subset of unique identifier data overlaid to any of a reference first input data into which the first input data is compared and a reference second input data into which the second input data is compared, the subset of unique identifier data being randomly selected from a set of unique identifier data, the set of unique identifier data being generated from any one or more color identifier data in a standardized color matching system.

17. A computer program product, comprising a non-transitory computer usable medium having a computer readable program code embodied therein, the computer readable program code causing a computer to implement a method for controlling access to an identity-based access-controlled resource using multimodal authenticity determination, the multimodal authenticity determination being directed to an object of authentication at an access point located in the access-controlled resource, the method comprising:
receiving a first input data including information on a first modality associated with the object of authentication;
deriving a first authentication data from the information on the first modality based on at least one first authentication parameter, the at least one first authentication parameter being based on the first modality;
determining at least one first authenticity score for the object of authentication by comparing the first authentication data with a first reference authentication data associated with the object of authentication and stored in an electronic database;
receiving a second input data including information on a second modality associated with the object of authentication based on acceptability of the determined at least one first authenticity score;
deriving a second authentication data from the information on the second modality based on at least one second authentication parameter, the at least one second authentication parameter being based on the second modality;
determining at least one second authenticity score for the object of authentication by comparing the second authentication data with a second reference authentication data associated with the object of authentication and stored in the electronic database;
receiving a third authentication data uniquely identifying the any of the first and second input data based on acceptability of the determined at least one second authenticity score;
determining at least one third authenticity score for the object of authentication by comparing the third authentication data with a third reference authentication data associated with the object of authentication and stored in the electronic database; and
causing an access control unit at the access point to grant access to the access-controlled resource based on acceptability of the determined at least one third authenticity score,
wherein the third reference authentication data includes at least one digital key generated based at least in part on a determined distance of at least two unique identifier data in relation to one another, the at least two unique identifier data being included in a subset of unique identifier data overlaid to any of a reference first input data into which the first input data is compared and a reference second input data into which the second input data is compared, the subset of unique identifier data being randomly selected from a set of unique identifier data, the set of unique identifier data being generated from any one or more color identifier data in a standardized color matching system.
